(19) United States
(12) Patent Application Publication
(10) Pub. No.: US 2008/0104940 A1
(43) Pub. Date: May 8, 2008

(54) Device for Controlling a Gas Flow, a Jet Engine Comprising the Device and an Aircraft Comprising the Device

(75) Inventor: Bernhard Gustafsson, Goteborg (SE)

Correspondence Address: WRB-IP LLP, 1217 KING STREET, ALEXANDRIA, VA, 22314, US

(73) Assignee: VOLVO AERO CORPORATION, Trollhättan (SE)

(21) Appl. No.: 11/718,433

(22) PCT Filed: Oct. 21, 2005
(86) PCT No.: PCT/SE05/01589

§ 371 Date: May 2, 2007

(30) Foreign Application Priority Data
Nov. 5, 2004 (SE) 0402719-9

(51) Int. Cl. F02K 1/28; B05B 1/26

(52) U.S. Cl. 60/228; 239/265.11

(57) ABSTRACT

A device for controlling a gas flow comprises an outlet part which defines an internal space for the gas flow and a body arranged in the internal space in the vicinity of the outlet of the outlet part, a gap being formed between the body and the inner boundary wall of the outlet part. At least one opening is provided at the outlet of the outlet part for injection of a fluid into the gas flow for the purpose of controlling the direction of the gas flow out of the outlet part.

### BACKGROUND AND SUMMARY

The present invention relates to a device for controlling a gas flow. The invention will be described below for an outlet device of a jet engine. This is a preferred, but in no way restrictive application of the invention.

The term jet engine is intended to include various types of engines which take in air at a relatively low velocity, heat it up through combustion and expel it at a much higher velocity. The term jet engine includes turbojet engines and turbofan engines, for example.

The jet engine conventionally comprises a compressor section for compression of the intake air, a combustion chamber for combustion of the compressed air and a turbine section arranged behind the combustion chamber, the turbine section being rotationally connected to the compressor section in order to drive this by means of the energy-rich gas from the combustion chamber. The compressor section usually comprises a low-pressure compressor and a high-pressure compressor. The turbine section usually comprises a low-pressure turbine and a high-pressure turbine. The high-pressure compressor is rotationally locked to the high-pressure turbine via a first shaft and the low-pressure compressor is rotationally locked to the low-pressure turbine via a second shaft.

The jet engine can be used for the propulsion of various types of jet-propelled craft including both land and waterborne craft, but the invention is primarily intended for applications in an aircraft, and in particular in an airplane engine.

Protecting an airplane against possible attack by giving the airplane a low so-called signature is already known. The term signature in this context refers to the contrast with the background. A craft should have a low radar signature. Vertical surfaces, corners, edges and cavities can give rise to a radar signature. One method for reducing the radar signature is therefore to eliminate the vertical tail fin. A craft without a tail fin has to have some other method of lateral control. One way is to arrange a movable central body in the outlet nozzle, it being possible to adjust the central body to a number of positions in relation to the inner boundary wall of the nozzle. By controlling the direction of the central body in relation to the nozzle, the outlet jet from the jet engine can be laterally controlled, thereby controlling the lateral movement of the craft.

It is desirable to provide a device for controlling a gas flow, which provides an alternative method for controlling a craft. It is also desirable to provide a robust construction having a long service life.

A device according to an aspect of the present invention comprises an outlet part, which defines an internal space for the gas flow, and a body arranged in the internal space in the vicinity of the outlet of the outlet part. A gap is formed between the body and the internal boundary wall of the outlet part. At least one opening is provided at the outlet of the outlet part for the injection of a fluid into the gas flow, for the purpose of controlling the direction of the gas flow out of the outlet part.

This solution means that no moving parts are required for controlling the gas jet, which creates the prerequisites for a long service life, as the environment in the outlet is often aggressive with very high thermal loads. The wear of coatings in the outlet is reduced, since moving parts are eliminated. The solution furthermore gives a rapid response time with low hysteresis, if any. Internal mixing can be produced in the outlet jet, which is good from an acoustic and IR signature standpoint.

According to a preferred embodiment of the invention the device comprises an outlet device for a jet engine, and the central body is arranged so that in operation it conceals hot parts of the jet engine from rear view. In other words it blocks a direct view into the interior of the jet engine. All high-temperature parts of the engine, such as turbine parts, are therefore hidden completely from direct view.

According to a further preferred embodiment of the invention the device comprises an outlet device for a jet engine, and said opening is provided at the outlet of the outlet part for the injection of the fluid into the gas flow, for the purpose of controlling the direction of the gas flow out of the outlet part, in order to control a craft comprising the jet engine. Through selective asymmetrical fluid injection it is possible to achieve a vectored thrust and in this way to control the craft.

Further preferred embodiments and advantages of these are set forth in the following description, in the drawings and in the claims.

### BRIEF DESCRIPTION OF THE DRAWINGS

The invention will be described in more detail below with reference to the embodiment shown in the drawings attached, in which:

FIG. 1 shows a schematic, perspective view of an airplane comprising an aero engine with an outlet device according to the invention,

FIG. 2 shows a cross-sectional plan view of the aero engine with the outlet device according to a first embodiment,

FIG. 3 shows an enlargement of a control arrangement in a central body of the outlet device,

FIG. 4 shows a flow from an outlet device according to a second embodiment in operation,

FIG. 5 shows a perspective view of the outlet device according to FIG. 4,

FIG. 6 shows a partially sectional perspective view of an outlet device of the aero engine according to a third embodiment, and

FIG. 7 shows a sectional perspective view of an outlet device of the aero engine according to a fourth embodiment.

### DETAILED DESCRIPTION

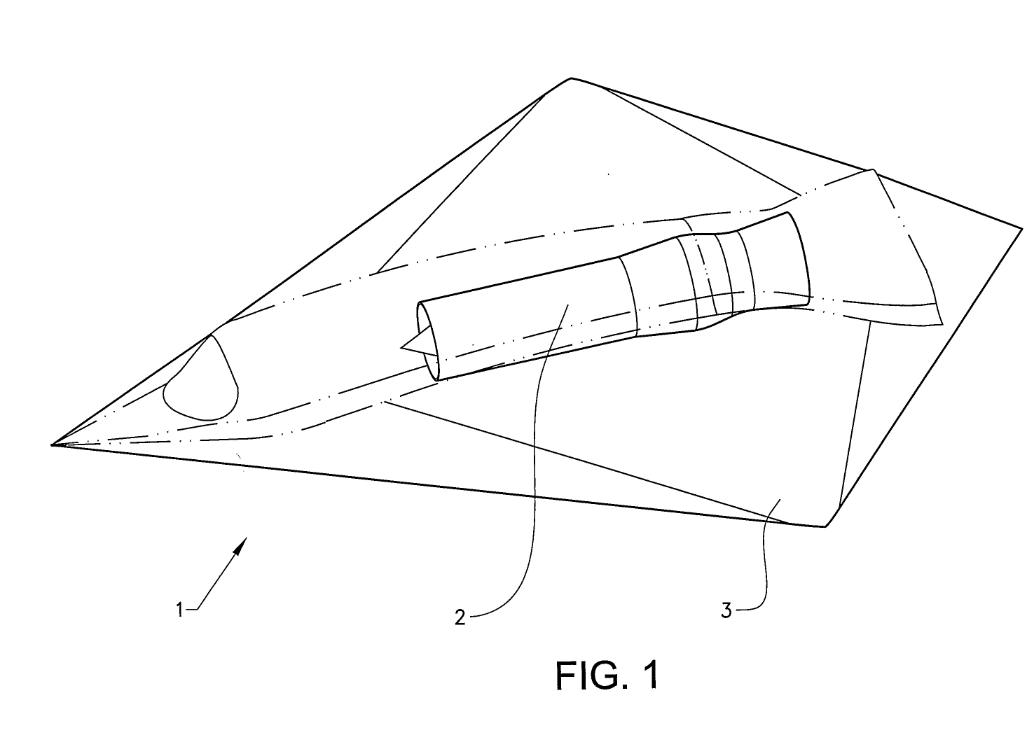

FIG. 1 shows a schematic, perspective view of an airplane 1 in the form of a stealth airplane without tail fin. A jet engine 2 having an outlet device 4 is located centrally in the airplane fuselage. A wing 3 projects in both directions from the aircraft fuselage laterally to the airplane.

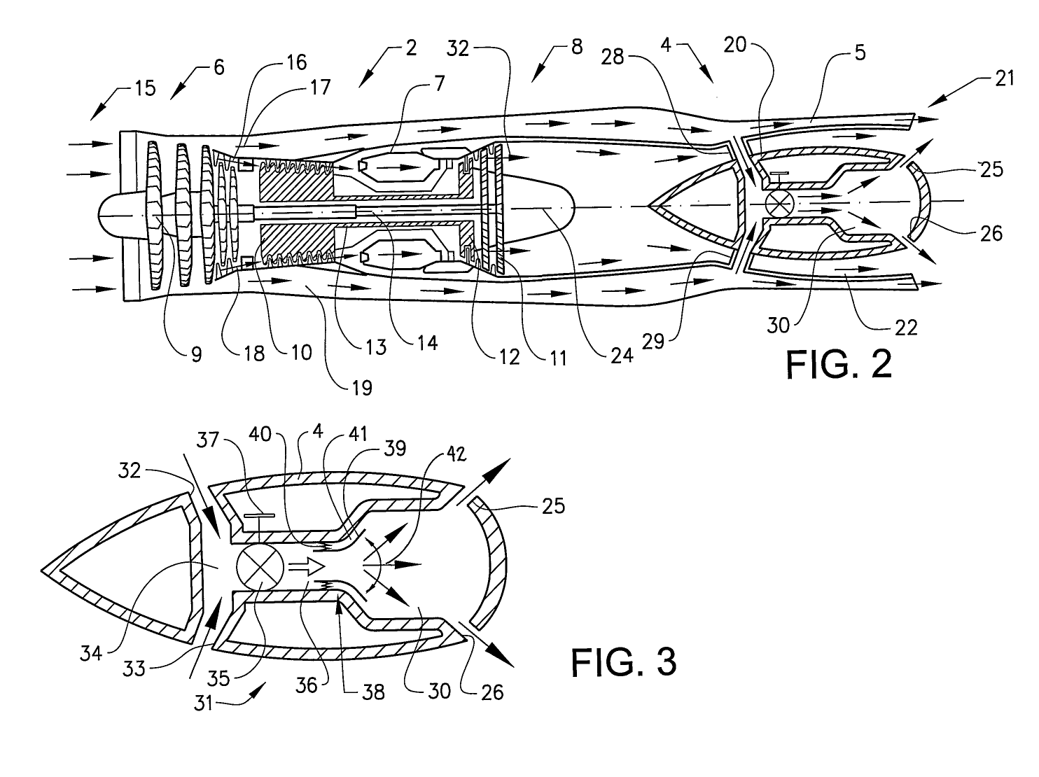

FIG. 2 shows a cross-sectional view of the jet engine 2. The jet engine 2 is of the double-flow type and has double rotors.

The jet engine 2 comprises a compressor section 6 for compression of the intake air, a combustion chamber 7 for combustion of the compressed air and a turbine section 8 arranged behind the combustion chamber, the turbine section being rotationally connected to the compressor section in order to drive this by means of the energy-rich gas from the combustion chamber. The compressor section 6 comprises a low-pressure part 9, or fan, and a high-pressure part 10. The turbine section 8 comprises a low-pressure part 11 and a high-pressure part 12. The high-pressure compressor 10 is rotationally locked to the high-pressure turbine 12 via a first shaft 13 and the low-pressure compressor 9 is rotationally locked to the low-pressure turbine 11 via a second shaft 14. In this way a high-pressure rotor and a low-pressure rotor are formed. These are supported concentrically and rotate freely in relation to one another.

The jet engine 2 is, as stated, of the double-flow type, which means that once it has passed through the fan 9 an intake air flow 15 is divided into two flows; an inner, compressor air flow 16, and an outer, fan air flow 17. The jet engine 2 therefore comprises a radially inner main duct 18 for a primary flow to the combustion chamber 7 and a radially outer duct 19 for a secondary flow (bypass for fan flow). The gas ducts 18, 19 are concentric and annular. The inner gas flow emerging from the jet engine 2 is hereinafter referred to as the core flow 32.

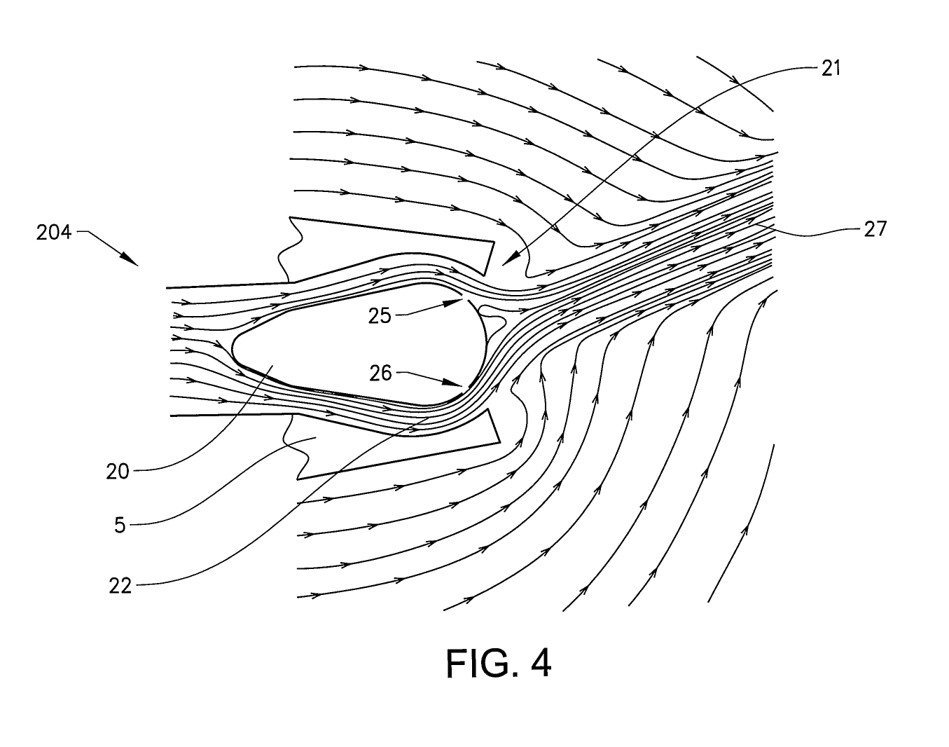

A first embodiment of the outlet device 4 is shown in FIG. 2. The outlet device 4 comprises an outlet part 5 in the form of an outlet nozzle and a central body 20 concentrically arranged in the outlet nozzle. The outlet nozzle 5 defines an internal space for an exhaust gas flow, or jet, from the jet engine 2 and the central body 20 is arranged in the internal space in the vicinity of the outlet 21 of the nozzle, an annular gap 22 being formed between the body 20 and the inner boundary wall of the nozzle 5. Hot parts of the jet engine, such as rear turbine parts 11, are hidden from rear view by the central body 20, which is advantageous for reducing the IR signature. The outlet nozzle 4 has a circular inner cross-sectional shape and the central body 20 has a circular outer cross-sectional shape, see also FIG. 4.

The central body 20 more specifically has an axi-symmetrical, aerodynamic, ovoid shape with a summit, or apex pointed backwards towards the jet engine. The central body 20 is arranged symmetrically in relation to the axial direction 24 of the engine.

The exhaust gas flow therefore flows around the central body 20. By blocking the flow through an injection of fluid in one or more positions, the flow is made to take another path and vectoring is achieved.

The central body 20 is fixed in relation to the outlet nozzle 5 by a number of stays 28, 29. The stays 28, 29 are arranged at an interval from one another in the circumferential direction of the jet engine. At their radially outer ends the stays 28, 29 are furthermore firmly connected to the outlet part 5.

The central body 20 comprises an internal chamber 30, which is connected to a plurality of openings 25, 26, 225, 226, which open out in a rear surface of the body 20, see also FIGS. 3 and 4. A first set, or group, of openings 25 is provided through the central body 20 in an area of a first side of a center line 24 through the central body 20. The openings in the first set are arranged at an interval from one another in the lateral direction of the central body 20. A second set, or group, of openings 26 is provided through the central body 20 in an area of a second side of a center line 24 through the central body 20.

Openings 25, 26 are intended for selective injection of a fluid into the nozzle, for the purpose of controlling the gas flow, that is to say the jet, through the nozzle. The fluid is therefore here injected to a varying extent through the openings 25, 26 on different sides of the center line. Alternatively the openings on one side are completely closed and injection occurs only through openings on the opposite side. The openings 25, 26 are located at a lateral distance from the center line 24 of the outlet nozzle 4. The openings 25, 26 are therefore arranged to right and left in the outlet device with respect to the location of the jet engine in the airplane, for the purpose of yaw vectoring.

A third set, or group, of openings 225 is provided through the central body 20 in an area below a center line 24 through the central body 20. The openings in the third set are arranged at an interval from one another in the vertical direction of the central body 20. A fourth set, or group, of openings 226 is provided through the central body 20 in an area above a center line 24 through the central body 20.

The openings 225,226 are intended for selective injection of a fluid into the nozzle for the purpose of controlling the gas flow, that is to say the jet, through the nozzle. The fluid is therefore here injected through the opening 225, 226 which is situated at a lateral distance from the center line 24 of the outlet nozzle 4. The openings 225,226 are therefore arranged at the top and bottom in the outlet device with respect to the location of the jet engine in the airplane, for the purpose of pitch vectoring.

Yaw and pitch vectoring can therefore be achieved with one and the same outlet device. Multi-axial vectoring is thereby feasible.

Each of the sets of openings 25, 26, 225, 226 comprises one or more basically parallel, slit-shaped openings. In the example shown, each such set comprises three slit-shaped openings. The four sets of openings here lie symmetrically with a 90° separation between the center of the groups.

The stays 28, 29 are preferably hollow for carrying a gas into the interior of the central body 20. The interior of the central body 20 is here flow-connected to the fan air duct 19.

An arrangement 31 for selectively controlling the fan intake air to said injection openings 25, 26 is shown schematically in FIG. 3. The fluid (the fan air) is led from the openings 32, 33 in the central body 4 into a first space 34. A control valve 35 is designed to selectively vary a flow from the first space 34 to a second space 36. The control valve can be selectively regulated by a suitable control system, in this case represented by a T-handle 37. The fluid is further directed/guided towards one or more of said openings 25, 26 by means of a control device 38.

The second chamber 36 widens out in the direction of the openings 25, 26. The second chamber 36 therefore has a divergent design shape. The fluid is controlled by means of a further fluid. The control device 38 is arranged in the second chamber 36 in the area of a divergent section. The control device 38 comprises one or more plate-shaped elements 39 mounted in the circumferential direction of the second chamber 36 and at a short distance from the inner wall thereof. Flow injectors 40 are arranged in the duct 41 between the plate-shaped element 39 and the wall for the injection of control gas, in the form of compressed air, preferably from the compressor section of the engine. The volume of control gas is substantially less than the volume of fluid that is to be directed/guided.

The control air from the duct 41 flows broadly parallel to the wall of the chamber at a high velocity, which generates a low static pressure, which draws the fluid jet 42 towards the wall of the chamber. The control air is mixed with the fluid jet and shifts its direction so that it is broadly parallel to the direction of flow of the control air. In this way selective injection into the openings 25, 26, 225, 226 is achieved.

FIG. 4 shows an outlet device 204 according to a second embodiment. In contrast to the embodiment shown in FIG. 2, in the second embodiment there is no separate, outer fan air flow. In a first alternative, a jet engine of the double-flow type is used, see the description above, the core air flow and the fan flow being united before they reach the outlet device 204. The outlet flow from the jet engine is in such a case made up of both the core flow and the fan air flow. In a second alternative a jet engine of single-flow type is used, the outlet flow from the jet engine being made up solely of the core flow.

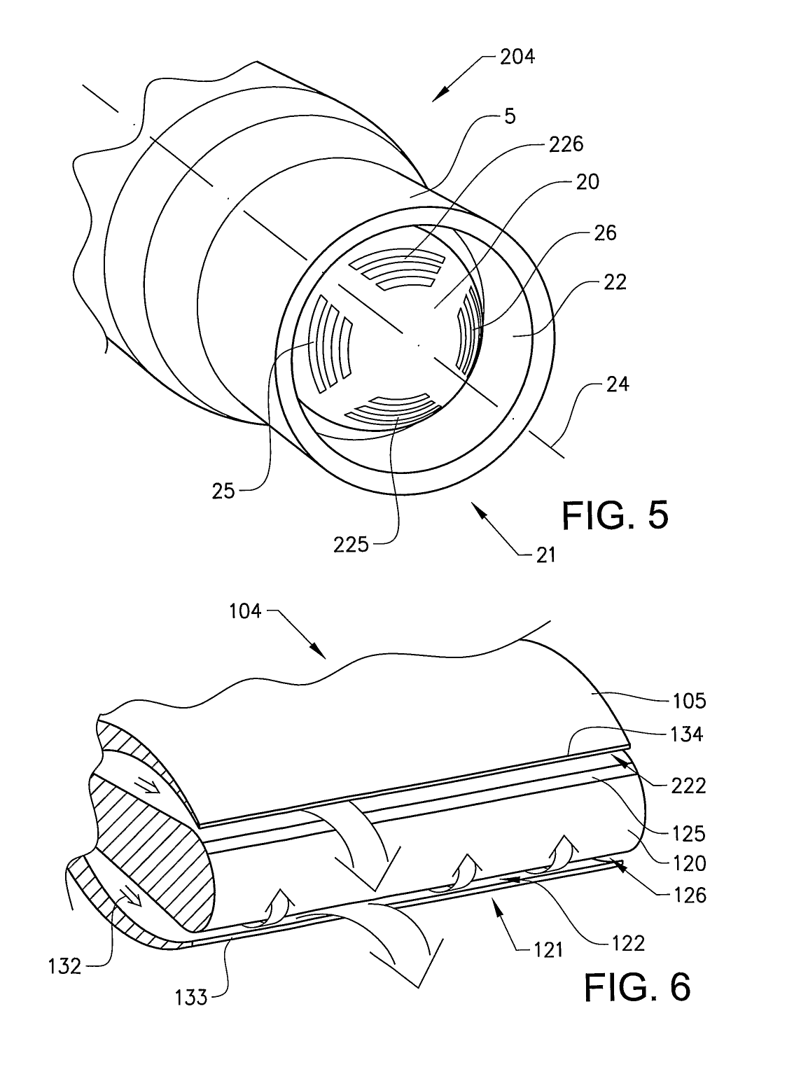

FIG. 4 illustrates more precisely the result of a CFD calculation of the flow through the outlet nozzle 204. The direction of the gas flow is shown by a jet 27. The jet 27 here emerges at an angle in relation to the axial direction 24 of the outlet nozzle 204. A plurality of openings 25 are preferably arranged at an interval from one another in the lateral direction of the jet engine, see FIG. 5, and the fluid is guided selectively to one or more of them for controlling a craft having the jet engine as propulsion source. In other words the thrust is vectored.

The fluid injection can furthermore be varied so that a variable vectoring is achieved. It is therefore no longer on/off-vectoring, but a continuous degree of vectoring.

Hot parts of the jet engine, such as rear turbine parts, are hidden from rear view by the central body 20. The duct (the gap) 22 between the central body 20 and the inner boundary wall of the outlet part 5 is furthermore designed so that radar waves have to bounce repeatedly on their way into the engine cavity. The surface is furthermore provided with radar-absorbing materials. This affords a low radar target area.

FIG. 6 shows an outlet device 104 according to a third preferred embodiment. The outlet part 105 of the outlet device 104 has an oblong, basically rectangular, inner cross-sectional shape and the central body 120 has a correspondingly wide, preferably rectangular outer cross-sectional shape. The outlet device 104 is intended to be arranged in an airplane in such a way that a long side of the outlet part 105 extends in the transverse direction of the airplane.

The outlet part 105 therefore has two opposing side walls (not shown), and an upper wall and a lower wall 133, 134, which are also opposed to one another. The central body 120 here extends basically in the lateral direction of the nozzle, or in other words in the transverse direction of the airplane. The central body 120 extends between, and is connected to the side walls (not shown) of the outlet part. A gap 122, 222 formed between the central body 120 and the inner boundary wall of the outlet nozzle 104 thereby acquires a basically linear shape. In the example shown there is a lower and an upper such linear gap 122, 222.

Hot parts of the jet engine, such as rear turbine parts, are hidden from rear view by the central body 120.

The central body 120 further comprises a chamber (not shown) and a plurality of openings 125, 126. A first opening 125 of these openings is arranged on an upper side of the central body 120 and a second opening 126 of these openings is arranged on an underside of the central body 120. The openings 125, 126 here have a slit shape and extend basically parallel to an opposing inner boundary wall of the outlet part 105. The slit-shaped openings 125, 126 furthermore extend basically parallel to one another.

The openings 125,126 are therefore arranged at the top and bottom of the outlet device with respect to the location of the jet engine in the airplane, for the purpose of pitch vectoring.

An outlet flow 132 from a jet engine (not shown), for example, is vectored through selective control of the flow out through the openings 125, 126. In contrast to the embodiment shown in FIG. 2, in the second embodiment there is no separate, outer fan air flow. In a first alternative, a jet engine of the double-flow type is used, see the description above, the core air flow and the fan flow being united before they reach the outlet device 104. The outlet flow 132 from the jet engine is in such a case made up of both the core flow and the fan air flow. In a second alternative a jet engine of the single-flow type is used, the outlet flow 132 from the jet engine being made up solely of the core flow.

In a complementary addition or alternative to an arrangement of openings through a rear surface of the central body 20, at least one opening opens out in a lateral surface of the body, which faces the inner boundary wall of the nozzle.

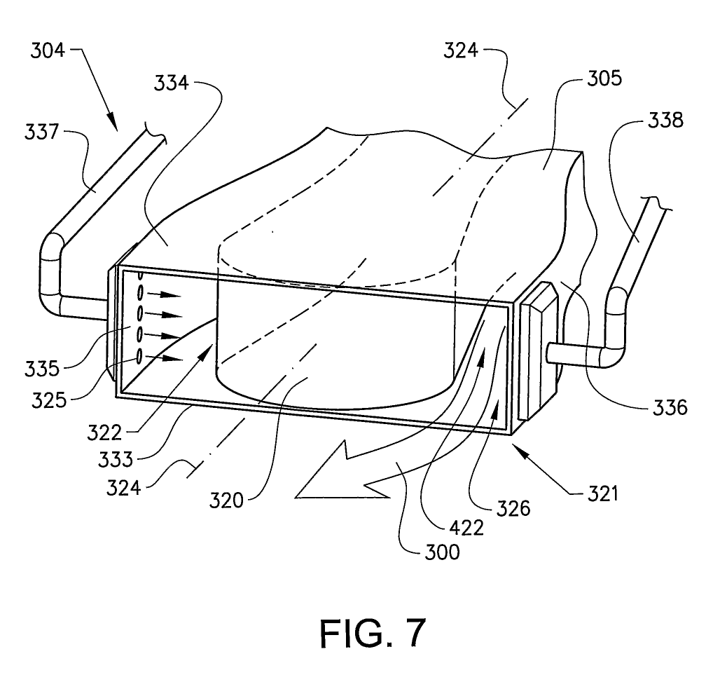

FIG. 7 shows an outlet device 304 according to a fourth preferred embodiment. The outlet part 305 of the outlet device 304 has an oblong, basically rectangular, inner cross-sectional shape. The outlet device 304 is intended to be arranged in an airplane in such a way that a long side of the outlet part 305 extends in the transverse direction of the airplane. The outlet part 305 therefore has two opposing side walls 335,336 and an upper wall and lower wall 333,334, which are also opposed to one another. The central body 320 extends between and is connected to the upper and lower boundary wall 333, 334 of the outlet part 305.

A gap 322,422 is formed between the central body 320 and the inner, right-hand and left-hand boundary walls 335, 336 of the outlet nozzle 304. In the example shown therefore there is a right-hand and a left-hand such gap 322, 422. Hot parts of the jet engine, such as rear turbine parts, are hidden from rear view by the central body 320.

At least one opening 325,326 is provided through one of the boundary walls of the outlet part 305, the wall facing the body 320. A set of openings 325, 326 is provided in each side wall 335, 336 at the outlet 321. The openings 325, 326 are punctual and form a row in each side wall 335, 336, the row extending in the vertical direction of the outlet part 305.

A line 337, 338 for the fluid which is to be injected extends to each of the sets of openings 325, 326. Injectors for controlling the fluid for correct opening are arranged at the orifice of the lines, in front of the openings. According to a first alternative, the lines 337, 338 carry gas from the compressor section of the jet engine.

The openings 325, 326 are therefore arranged to right and left in the outlet device with respect to the location of the jet engine in the airplane, for the purpose of yaw vectoring. An outlet flow from a jet engine (not shown), for example, is vectored through selective control of the flow out through the openings 325,326. FIG. 7 by way of example shows that the fluid is injected through the openings 325 in the left-hand side wall 335 of the outlet part 305. The gap 322 is thereby at least partially blocked for the gas flow (the jet) from the jet engine. The gas flow 300 instead then flows through the right-hand gap 422 and vectoring occurs to the left (see the direction of the arrow 300).

As in the embodiment shown in FIG. 6, there is no separate, outer fan air flow in the fourth embodiment.

As an alternative to a fixed arrangement of the central body in relation to the outlet nozzle, the central body can feasibly be arranged so that it is moveable and can be adjusted to various positions in relation to the inner boundary wall of the outlet nozzle. The central body can be rotatably arranged, or arranged so that it is laterally moveable in relation to inner wall of the nozzle. By controlling the adjustment of the central body it is also possible to influence the direction of the thrust.

The central body may be linearly displaceable, for example, to and fro in the axial direction of the outlet device. It is thereby possible to vary the shape and size of the gap that exists between the central body and the internal boundary wall of the outlet part. The central body may furthermore be arranged so that it can rotate about the center line 24.

If the central body is non-axi-symmetrical, see FIGS. 6 and 7, for example, the central body may be arranged so that it can rotate about an axis which extends perpendicular to the axial direction of the outlet device. By adjusting the central body to different positions it is possible to boost the vectoring effect.

The shape and size of the openings can be varied. The scope of the invention allows for the use both of a plurality of smaller holes, and some larger openings, in the form of slits, for example. The prescription of a gap 22, 122, 222, 322, 422, formed between the central body 20, 120, 220, 320 and the inner boundary wall of the outlet part 5, 105, 205, 305, encompasses various shapes of the intervening space between the body and the wall, and is not solely limited to a gap of the same height over the whole of its length, but includes different heights along different parts of the gap. A plurality of discrete gaps may furthermore be arranged between the body and the wall.

In an alternative to the embodiment shown in FIG. 5, the central body comprises three sets of openings, of which two sets are arranged on different sides of the center line of the central body in the lateral direction of the outlet device and two sets are arranged on different sides of the center line of the outlet device in the vertical direction of the outlet device. It is suggested that the three sets of openings should lie symmetrically with a 120° separation between the groups.

In a further alternative to the embodiment shown in FIG. 5, one or more openings may have be large in extent, and may even be continuous, in the circumferential direction of the central body. Vectoring is then achieved in that the control device 31 controls the injected flow to specific sections of such openings elongated in the circumferential direction.

In a further alternative to the embodiment shown in FIG. 5, there is just one set of openings on one side of the center line 24 of the central body. This single set of openings suitably takes up a limited angle of the central body in its circumferential direction, for example <90°. The central body is further more arranged so that it can rotate about the center line 24. In vectoring, therefore, the central body is rotated so that the single set of openings ends up in the required position and the fluid is then injected through the openings.

In an alternative to the embodiment shown in FIG. 7 there is a fan air duct around the casing 305, which defines the space in which the central body 320 is located. In this case the lines 337, 338 can be eliminated and fan air can be led into the openings 325, 326 in order to achieve the vectoring.

Furthermore, the central body and/or the outlet part can be cooled by the injected fluid, for example, so that the surface temperature of the central body, especially in rear aspects, is reduced, thereby reducing the IR signature. The cooling can take place internally in the central body, by impingement-cooling, or externally on the central body, by film cooling. The fluid used for cooling may be drawn in from outside, for example, that is to say it may consist of comprise ram air. The ram air is then separated from the fan flow and the core flow.

Opposing surfaces of the central body and/or the outlet part are furthermore preferably designed with a low reflectivity in order to further reduce the IR signature.

The invention must not be regarded as being limited to the exemplary embodiments described above, a number of further variants and modifications being feasible without departing from the cope of the following patent claims. It is in particular pointed out that the two embodiments illustrated can be combined in various ways.

The control device inside the central body for selective deflection of the fluid to one or more of the openings may be formed in a number of different ways. According to a first example the control device comprises a porous section, or a hole configuration, provided in the wall of the second chamber. Suction from outside through the porous section/the hole configuration serves to deflect the fluid from the axial direction. According to a second example the control device comprises a rotatable structure, which does not require any control air, but which comprises control elements in the form of moving blades or the like, which influence the fluid differently in different positions.

In a further alternative the central body is firmly connected to a rear engine case and may then form an outlet cone from the engine. This central body should then replace the engine outlet cone (see FIG. 2) which extends in an axial direction downstream of the turbine rotor 11.

The embodiments described above can be combined in a number of different ways. For example, where the outlet device has an axi-symmetrical central body (see FIG. 5, for example) one or more openings may be provided through a boundary wall of the outlet part.

The invention is, for example, not limited to a jet engine. There are all manner of feasible applications in which there is a need to be able to control the direction of a gas jet. For example, the device may be used as rudder via a gap in the trailing edge of an aircraft wing, replacing a part of the control surfaces. The third embodiment shown in FIG. 6, in particular, might form a trailing edge, or part of a trailing edge, and the vectoring could then replace rudder surfaces, which can result in a reduced radar signature. Further alternative applications of the invention occur in a robot, a rocket or a satellite, for controlling these. Alternative propulsion sources, such as a rocket motor, for example a black powder motor, are also feasible.

1. An outlet device for controlling a gas flow from a jet engine, comprising an outlet part, the outlet part defining an internal space for the gas flow, and a body arranged in an internal space of the outlet part proximate an outlet of the outlet part, a gap being formed between the body and an inner boundary wall of the outlet part, wherein the body is arranged so that in operation it conceals hot parts of the jet engine from rear view, and at least one opening is provided at the outlet of the outlet part for injection of a fluid into the gas flow for the purpose of controlling a direction of the gas flow out of the outlet part in order to control a craft comprising the jet engine.

2. The device as claimed in claim 1, wherein at least one of the at least one opening is provided through the body.

3. The device as claimed in claim 2, wherein at least one of the at least one opening opens out in a rear surface of the body.

4. The device as claimed in claim 2, wherein at least one of the at least one opening opens out in a lateral surface of the body, which faces the inner boundary wall of the outlet part.

5. The device as claimed in claim 1, wherein at least one of the at least one opening is provided through a boundary wall of the outlet part, which wall faces the body.

6. The device as claimed in claim 1, wherein the outlet part has a circular inner cross-sectional shape at the gas outlet.

7. The device as claimed in claim 1, wherein the outlet part has a transversely oblong inner cross-sectional shape at the gas outlet.

8. The device as claimed in claim 1, wherein the body is fixed in the outlet part.

9. The device as claimed in claim 1, wherein the body is moveably arranged in the outlet part.

10. The device as claimed in claim 1, wherein the body has an outer cross-sectional shape which corresponds substantially to an inner cross-sectional shape of the outlet.

11. The device as claimed in claim 1, wherein the inner boundary wall of the outlet has a curved shape in an axial direction of the device.

12. The device as claimed in claim 1, wherein the device comprises an outlet device for a propulsion source which generates the gas flow, and the at least one opening is provided at the outlet of the outlet part for injection of the fluid into the gas flow.

13. The device as claimed claim 1, wherein the device comprises an outlet device for a jet engine, and that the at least one opening is provided at the outlet of the outlet part for injection of the fluid into the flow.

14. The device as claimed in claim 1, wherein the device comprises at least two openings which are arranged on different sides of a center line of the body.

15. The device as claimed in claim 1, wherein the device comprises at least three sets of openings, of which two sets are arranged on different sides of a center line of the body in a lateral direction of the outlet device and two sets are arranged on different sides of the center line of the body in a vertical direction of the outlet device.

16. A jet engine, comprising a device as claimed in claim 1 for controlling an outlet gas flow from the jet engine.

17. An aircraft comprising a device as claimed in claim 1 for controlling a gas flow.

18. The device as claimed in claim 3, wherein at least one of the at least one opening opens out in a lateral surface of the body, which faces the inner boundary wall of the outlet part.
